(19) United States
(12) Patent Application Publication
(10) Pub. No.: US 2019/0283359 A1
(43) Pub. Date: Sep. 19, 2019

(54) MULTILAYERED TUBING FOR FUEL TRANSFER APPLICATIONS

(71) Applicant: Saint-Gobain Performance Plastics Corporation, Solon, OH (US)

(72) Inventor: James Ludlow, Medina, OH (US)

(21) Appl. No.: 16/358,535

(22) Filed: Mar. 19, 2019

Related U.S. Application Data
(60) Provisional application No. 62/645,041, filed on Mar. 19, 2018.

(51) Int. Cl. B32B 1/08; B32B 27/08

(52) U.S. Cl. CPC B32B 1/08; B32B 2597/00; B32B 27/08

(57) ABSTRACT

The present disclosure relates generally to polymer-based tubing, suitable, for example, for conducting hydrocarbon fuels. The present disclosure relates more particularly to multi-layered tubings that are fuel resistant, flexible, and cost effective.

### CROSS-REFERENCE TO RELATED APPLICATIONS

This application claims the benefit of priority of U.S. Provisional Patent Application No. 62/645,041, filed Mar. 19, 2018, which is hereby incorporated by reference herein in its entirety.

### BACKGROUND OF THE DISCLOSURE

### Field of the Disclosure

The present disclosure relates generally to polymer-based tubing, suitable, for example, for conducting hydrocarbon fuels. The present disclosure relates more particularly to multi-layered tubings that are fuel resistant, flexible, and cost effective.

### Technical Background

Multilayered or laminated rubber tubings are known to be useful to serve as a fuel transporting hose for a hydrocarbon fuel feed line into a vehicle or device reservoir. Such tubings are generally required to have a low permeability to fuel vapor, so as to reduce the amount of hydrocarbon vapor released to the environment. The United States Environmental Protection Agency sets certain regulations that limit the release of hydrocarbons into the environment. The regulations for handheld devices and marine applications are more stringent, requiring a maximum permeation rate of less than 15 g/m²/day and less than 5 g/m²/day, respectively. The permeation measurements are performed on circulating fuel, measuring the capture of hydrocarbons permeating through the tube wall at a test temperature of 40° C.

It is highly desirable that fuel tubings meet the most rigorous requirements for permeability to fuel vapor. To meet these strict evaporative emission standards, barrier layers are often used in fuel tubing. Thermoplastic fluoropolymers are an especially attractive material for use as barrier layers. They have a unique combination of properties, such as high thermal stability, chemical inertness and non-stick release properties. But thermoplastic fluoropolymers are expensive in comparison to many other polymers, and often do not provide the necessary strength and flexibility to a tubing. Accordingly, tubings are often formed as multilayer structures, in which one or more additional polymer layers can contribute their own properties and advantages such as, for example, low density, elasticity, sealability, scratch resistance and the like. Co-extrusion is often used to form such multilayer tubings.

Chemically functionalized fluoropolymers are often used as a barrier layer. Such materials are relatively flexible, however, they are expensive. They can also require barrier layers of 0.010″ (˜0.254 mm) and thicker to meet evaporative emission standards.

Therefore, there remains a need for improved and flexible multilayer fuel tubing that are not only chemically resistant to hydrocarbon fuels and have very low permeability to hydrocarbon fuels, but also have lower costs.

### SUMMARY OF THE DISCLOSURE

In one aspect, the present disclosure provides a length of tubing having an annular cross-section, the annular cross-section having an inner surface and an outer surface, the annular cross-section including:
an annular fluoropolymer barrier layer formed from at least 75 wt % of a CPT polymer, the fluoropolymer barrier layer having an outer surface and an inner surface; and
an annular thermoplastic layer (e.g., an annular thermoplastic polyurethane layer formed from at least 75 wt % thermoplastic polyurethane) disposed about the fluoropolymer layer, the thermoplastic polyurethane layer having an inner surface and an outer surface, the annular thermoplastic layer being disposed outside the annular fluoropolymer layer (e.g., at the outer surface of the annular cross section).

In another aspect, the disclosure provides methods for transporting a hydrocarbon fuel, the method including
providing a length of tubing having an annular cross-section, the annular cross-section having an inner surface and an outer surface, the annular cross-section including:
   an annular fluoropolymer layer formed from at least 75 wt % of a CPT polymer, the fluoropolymer layer having an outer surface and an inner surface; and
   an annular thermoplastic layer (e.g., an annular thermoplastic polyurethane layer formed from at least 75 wt % thermoplastic polyurethane) disposed about the fluoropolymer layer, the thermoplastic layer having an inner surface and an outer surface; and
      flowing the hydrocarbon fuel through the flexible tubing from a first end to a second end thereof.

In another aspect, the disclosure provides fuel-powered devices including:
a fuel tank,
a fuel-powered engine, and
a length of tubing fluidly connecting the fuel tank with the fuel-powered engine, and having an annular cross-section, the annular cross-section having an inner surface and an outer surface, the annular cross-section including:
an annular fluoropolymer layer formed from at least 75 wt % of a CPT polymer, the fluoropolymer layer having an outer surface and an inner surface; and
an annular thermoplastic layer (e.g., an annular thermoplastic polyurethane layer formed from at least 75 wt % thermoplastic polyurethane) disposed about the fluoropolymer layer, the thermoplastic polyurethane layer having an inner surface and an outer surface.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a side schematic view of a length of tubing according to one embodiment of the disclosure;

FIG. 2 is a cross-sectional schematic view of the length of tubing of FIG. 1; and

FIG. 3 is a cross-sectional schematic view of a length of tubing according to another embodiment of the disclosure.

### DETAILED DESCRIPTION

Before the disclosed processes and materials are described, it is to be understood that the aspects described herein are not limited to specific embodiments, apparati, or configurations, and as such can, of course, vary. It is also to be understood that the terminology used herein is for the purpose of describing particular aspects only and, unless specifically defined herein, is not intended to be limiting.

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used in the specification and the appended claims, the singular forms “a,” “an” and “the” include plural referents unless the context clearly dictates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

In view of the present disclosure, the methods and compositions described herein can be configured by the person of ordinary skill in the art to meet the desired need. In general, the disclosed materials, methods, and apparati provide improvements in multilayer fuel tubing. The inventors have unexpectedly determined that use of thin CPT-based fluoropolymer material of the tubing can provide a flexible tubing that has a high resistance to hydrocarbon fuels and to permeance of fuel vapors, but also reduces overall costs for the tubing.

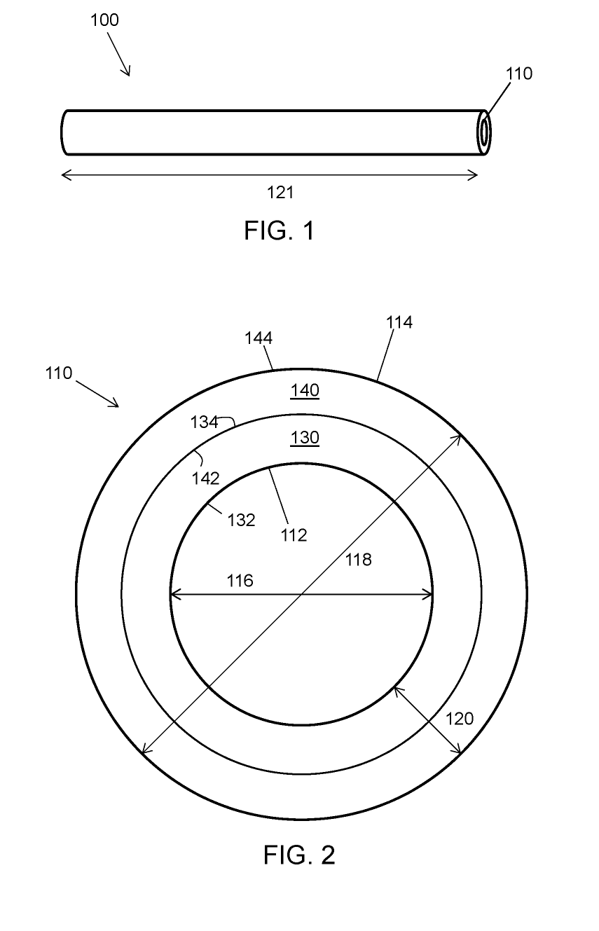

Accordingly, one aspect of the disclosure is a length of flexible tubing having an annular cross-section, the annular cross-section having an inner surface and an outer surface. Such a tubing is shown in schematic perspective view in FIG. 1, and in schematic cross-sectional view in FIG. 2. Flexible tubing 100 includes has an annular cross-section 110 (shown in detail in FIG. 2), which has an inner surface 112, an outer surface 114, an inner diameter 116 and an outer diameter 118. The inner diameter and the outer diameter define a wall thickness 120 of the tubing. Flexible tubing 100 also has a length 121.

Flexible tubing 100 is shown as being circular in overall shape. Of course, the person of ordinary skill in the art will appreciate that the tubing can be fabricated in other overall shapes, e.g., oval, elliptical, or polygonal. Similarly, while flexible tubing 100 is shown as having a radially constant wall thickness, the person of ordinary skill in the art will appreciate that in other embodiments, the thickness need not be constant. In such cases, the “thickness” is taken as the radially-averaged thickness. In certain desirable embodiments, the wall thickness at any one point along the circumference of the tubing is not less than 50%, e.g., no less than 60%, or no less than 70% of the average wall thickness.

The annular cross-section of the tubing 100 comprises an annular fluoropolymer layer 130, which is formed from at least 75 wt % CPT, and has an inner surface 132 and an outer surface 134. Disposed about the fluoropolymer layer is an annular thermoplastic layer 140, having an inner surface 142 and an outer surface 144. In the embodiment of FIG. 1, and in certain embodiments as otherwise described herein, the inner surface 142 of the thermoplastic layer is in contact with the outer surface 134 of the fluoropolymer layer.

The person of ordinary skill in the art will appreciate that the tubings of the disclosure can be configured in many ways. For example, in certain embodiments as otherwise described herein, the only two continuous polymeric layers of the tubing are an inner fluoropolymer layer, in contact with an outer thermoplastic layer.

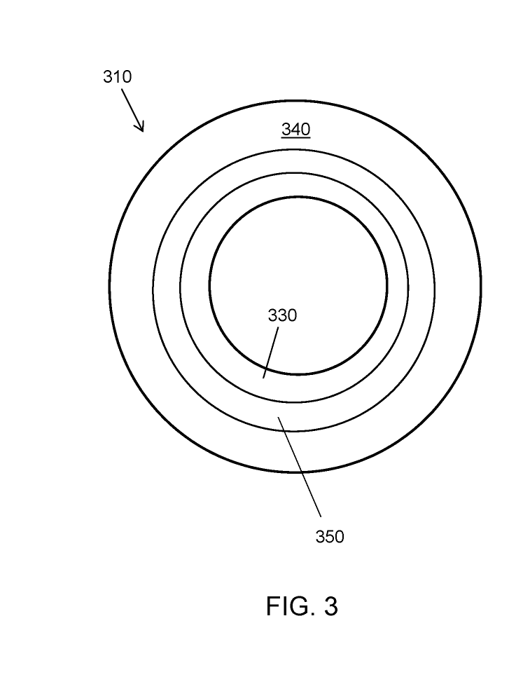

In other embodiments as otherwise described herein, the annular cross-section further includes one or more inner annular tie layers disposed on the outside surface of the fluoropolymer layer. Such an embodiment is shown in the cross-sectional schematic view of FIG. 3. Here, annular cross-section 310 includes not only a fluoropolymer layer 330 and a thermoplastic layer 340, but also one or more (here, one) inner annular tie layers 350 disposed on the outside surface of the fluoropolymer layer (i.e., between the outside surface of the fluoropolymer layer and the inner surface of the annular thermoplastic layer). The annular tie layers can help to adhere the fluoropolymer layer to the other layers of the tubing. For example, in certain embodiments, the one or more tie layers can (i.e., together) contact both the outer surface of the annular fluoropolymer layer and the inner surface of the annular thermoplastic layer. In certain embodiments as otherwise described herein, the only three continuous polymeric layers of the tubing are an inner fluoropolymer layer, an outer thermoplastic layer, and a tie layer disposed between them and contacting both.

In certain desirable embodiments, the fluorinated layer comprising the CPT polymer can be disposed at the inner surface of the tubing, i.e., to provide the fuel-contacting surface of the tubing. But in other embodiments, the fluorinated layer comprising the CPT polymer is in between two other annular layers of the annular cross-sectional structure of the tubing.

As described above, the fluoropolymer layer is formed from a substantial amount of, i.e., at least 75 wt %, CPT fluoropolymer. As used herein, the person of ordinary skill in the art will appreciate that “at least 75% of a CPT polymer” includes use of a plurality of CPT polymers in a total amount of at least 75%; analogous statements related other amounts and other polymers will be understood similarly. CPT, as used herein, is a copolymer of chlorotrifluoroethylene (CTFE), tetrafluoroethylene (TFE), and perfluoro(alkyl vinyl ether) (PFA). In certain desirable embodiments, such copolymers have at least 75 wt % of fluorinated monomeric subunits, e.g., at least 90 wt % of or even consist essentially of fluorinated monomeric subunits.

Desirable CPT copolymers include, for example, copolymers of only CTFE, TFE, and PFA. Commercially available CPT fluoropolymers include, for example, those fluoropolymers having the trade designations; “NEOFLON” (e.g., “NEOFLON™ CPT LP-Series” as marketed by Daikin Industries, Ltd. Other examples include copolymers as described in U.S. Patent Publication No. 2007/0219333 and U.S. Pat. No. 8,530,014, both incorporated herein in their entirety.

For example, in certain embodiments of the tubings as otherwise described herein, the fluoropolymer layer is formed from at least 80 wt %, e.g., at least 85 wt %, or at least 90 wt %, of a CPT polymer. In certain embodiments of the tubings as otherwise described herein, the fluoropolymer layer is formed from at least 95 wt % of, e.g., at least 98 wt % of, or consists essentially of, a CPT polymer.

Other fluorinated materials can be used in the fluoropolymer layer, together with the CPT polymer. For example, in certain embodiments of the tubings as otherwise described herein, the fluoropolymer layer include a fluorinated polyvinylidene polymer or copolymer (“a PVDF polymer”), a fluorinated ethylene propylene copolymer (“a FEP polymer”), a copolymer of tetrafluoroethylene and perfluoropropyl vinyl ether (“a PFA polymer”), a copolymer of tetrafluoroethylene and perfluoromethyl vinyl ether (“a MFA polymer”), a copolymer of ethylene and tetrafluoroethylene (“an ETFE polymer”), copolymer of ethylene, tetrafluoroethylene, and hexafluoropropylene (“an EFEP polymer”), a copolymer of ethylene and chlorotrifluoroethylene (“an ECTFE polymer”), polychlorotrifluoroethylene (“a PCTFE polymer”), a terpolymer including tetrafluoroethylene, hexafluoropropylene, and vinylidenefluoride (“a THV polymer”), or a combination or copolymer thereof. And the person of ordinary skill in the art will understand that other fluorinated polymers can be used; desirably, the polymer has at least 75 mol %, e.g., at least 90 mol %, or even at least 95 mol % fluorinated monomer residues. The person of ordinary skill in the art will appreciate that a variety of commercial fluoropolymer grades can be suitable for use in the tubings described herein.

And in certain embodiments as otherwise described herein, a fluoropolymer layer can include a minor amount (for example, no more than 25 wt %, e.g., no more than 10 wt %, or no more than 5%) of nonfluorinated polymer. Desirably, such polymer is miscible with, or otherwise compatible with the fluoropolymer. Non-fluorinated polymers can be used, for example, to modify the properties of the fluorinated polymer(s) of the polymer layer.

The person of ordinary skill in the art will appreciate that a variety of additional materials can be used in the fluoropolymer layer, e.g., to aid in processing or to provide a desired appearance of the fluoropolymer layer.

While the fluoropolymer layer can be formed in variety of thicknesses, the inventors have unexpectedly found that the fluoropolymer layers of no more than 0.200 mm in thickness afford significant cost savings yet meet the necessary permeance of fuel vapor standards. The person of ordinary skill in the art will, based on the disclosure herein, balance material properties, fuel vapor permeance properties and cost, among other factors, to provide a desired thickness of the fluoropolymer layer. In certain embodiments of the tubings as otherwise described herein, the fluoropolymer layer has a thickness in the range of about 0.010 mm to about 0.200 mm. For example, in various embodiments as otherwise described herein, the fluoropolymer layer has a thickness in the range of about 0.010 mm to about 0.150 mm, or about 0.010 mm to about 0.130 mm, or about 0.010 mm to about 0.100 mm, or about 0.010 mm to about 0.075 mm. In various embodiments as otherwise described herein, the fluoropolymer layer has a thickness in the range of about 0.030 mm to about 0.200 mm, e.g., about 0.030 mm to about 0.150 mm, or about 0.030 mm to about 0.130 mm, or about 0.030 mm to about 0.100 mm, or about 0.030 mm to about 0.075 mm. In various embodiments as otherwise described herein, the fluoropolymer layer has a thickness in the range of about 0.050 mm to about 0.200 mm, or about 0.050 mm to about 0.150 mm, or about 0.050 mm to about 0.130 mm, or about 0.050 mm to about 0.100 mm, or about 0.050 mm to about 0.075 mm. In various embodiments as otherwise described herein, the fluoropolymer layer has a thickness in the range of about 0.100 mm to about 0.200 mm, or about 0.100 mm to about 0.150 mm, or about 0.100 mm to about 0.130 mm, or about 0.150 mm to about 0.200 mm, or about 0.170 mm to about 0.200 mm. The fuel vapor permeance will generally be a function of layer thickness, and the thickness needed to provide a particular desired permeance will depend on the identity of the fluoropolymer layer.

In certain desirable embodiments of the tubings as otherwise described herein, the thermoplastic layer is a thermoplastic polyurethane layer formed from a substantial amount of, i.e., at least 75 wt %, thermoplastic polyurethane. The person of ordinary skill in the art will appreciate that a variety of additional materials can be used in the thermoplastic polyurethane layer, e.g., stabilizers, waxes, among others, to, for example, aid in processing or to provide a desired appearance or reduce the tack of the thermoplastic polyurethane layer. In certain embodiments of the tubings as otherwise described herein, the thermoplastic polyurethane layer is formed from at least 80 wt % thermoplastic polyurethane, e.g., or at least 85 wt % thermoplastic polyurethane, or at least 90 wt % thermoplastic polyurethane. In certain embodiments of the tubings as otherwise described herein, the thermoplastic polyurethane layer is formed from at least 95 wt % thermoplastic polyurethane, or even at least 98 wt % thermoplastic polyurethane. In other embodiments as otherwise described herein, the thermoplastic polyurethane layer consists essentially of thermoplastic polyurethane.

A variety of thermoplastic polyurethane materials can be used as the thermoplastic polyurethane material of the thermoplastic polyurethane layer. The person of ordinary skill in the art will appreciate that there are a variety of thermoplastic polyurethane materials that provide desired mechanical properties to a tubing and are amenable to formation into tubings by extrusion. The person of ordinary skill in the art will, based on the present disclosure, select an appropriate thermoplastic polyurethane to provide any other desirable properties, for example, adequate fuel/chemical resistance, flexibility, a low glass transition temperature (e.g., using a soft-segment phase) for low temperature applications, adequate weatherability/UV resistance, and adequate mechanical strength to withstand installation, to maintain fitting retention, and to maintain a seal in use.

Typically, a thermoplastic polyurethane is formed by reacting a polyol with an isocyanate. As the person of ordinary skill in the art will appreciate, the overall properties of the polyurethane will depend, among other things, upon the type of polyol and isocyanate, crystallinity in the polyurethane, the molecular weight of the polyurethane and chemical structure of the polyurethane backbone. Many typical thermoplastic polyurethanes also include a chain extender such as 1,4-butanediol that can form hard segment blocks in the polymer chain. Polyurethanes can generally be classified as being either thermoplastic or thermoset, depending on the degree of crosslinking present. Thermoplastic urethanes do not have primary crosslinking while thermoset polyurethanes have a varying degree of crosslinking, depending on the functionality of the reactants. As used herein, a “thermoplastic polyurethane” is one in which at least 95 mol % of, (in some embodiments, at least 99 mol % of, or even substantially all of) its polyol constituent is difunctional. As described in more detail below, such materials can be crosslinked by electron beam treatment; despite such crosslinking, the present disclosure considers such materials “thermoplastic.”

Thermoplastic polyurethanes are commonly based on either methylene diisocyanate or toluene diisocyanate and include both polyester and polyether grades of polyols. Thermoplastic polyurethanes can be formed by a “one-shot” reaction between isocyanate and polyol (e.g., with optional chain extender) or by a “pre-polymer” system, wherein a curative is added to the partially reacted polyolisocyanate complex to complete the polyurethane reaction. Examples of some common thermoplastic polyurethane elastomers based on “pre-polymers” are “TEXIN”, a tradename of Bayer Materials Science, “ESTANE”, a tradename of Lubrizol, “PELLETHANE”, a tradename of Lubirzol, and “ELASTOLLAN”, a tradename of BASF.

In certain embodiments of the tubings as described herein, the thermoplastic polyurethane layer is a polyether-type thermoplastic polyurethane, a polyester-type thermoplastic polyurethane, or a combination or copolymer thereof. Typically, thermoplastic polyurethanes used in fuel tubings are ester-type thermoplastic polyurethanes. Ester-type thermoplastic polyurethanes can be based on different compositions of substituted or unsubstituted methane diisocyanate (MDI) and a substituted or unsubstituted dihydroxy alcohol (a glycol).

In certain advantageous embodiments of the tubings as otherwise described herein, the thermoplastic polyurethane of the thermoplastic polyurethane layer is a polyether-type polyurethane. Polyether-type thermoplastic polyurethanes can be more resistant to hydrolytic degradation than polyester-type thermoplastic polyurethanes. But the fact that they generally have lower resistance to hydrocarbons makes polyether-type thermoplastic polyurethanes generally less suitable than polyester-type polyurethanes for use in conventional fuel tubings. But the softness of some grades of polyether-type thermoplastic polyurethanes can make them more suitable for use in tubings like those described here.

Of course, in other embodiments, the thermoplastic layer can be formed from other non-fluorinated thermoplastic polymers. Examples of other examples of materials that can be suitable for use in thermoplastic layers include, for example, polyamide resins, polyester resins, ethylene acrylic acid and methacrylic acid copolymer resins, polyolefin resins, vinyl chloride-based resins, polyurethane resins, polyaramid resins, polyimide resins, polyamideimide resins, polyphenylene oxide resins, polyacetal resins, polyetheretherketone resins (PEEK), polyetherimide resins, ethylene/vinyl alcohol copolymer-based resins, polyphenylene sulfide resins, polybutylene naphthalate resins, polybutylene terephthalate resins, polyphthalamides (PPA), polyphenylene sulfide (PPS), and a combination or copolymer thereof.

The thermoplastic layer can be formed in variety of thicknesses. The person of ordinary skill in the art will, based on the disclosure herein, balance material properties and cost, among other factors, to provide a desired thickness of the thermoplastic layer. In certain embodiments of the tubings as otherwise described herein, the thermoplastic layer has a thickness in the range of about 0.5 mm to about 20 mm. For example, in various embodiments as otherwise described herein, the thermoplastic layer has a thickness in the range of 0.5 mm to 10 mm, or 0.5 mm to 5 mm, or 0.5 mm to 3 mm, or 0.5 mm to 2 mm, or 1 mm to 20 mm, or 1 mm to 10 mm, or 1 mm to 5 mm, or 1 mm to 3 mm, or 2 mm to 20 mm, or 2 mm to 10 mm, or 2 mm to 7 mm, or 2 mm to 5 mm, or 5 mm to 20 mm, or 5 mm to 15 mm, or 5 mm to 10 mm, or 10 mm to 20 mm.

In certain embodiments, the material volume of the tubing is at least 50%, at least 70%, at least 90%, or even at least 95% made up of the thermoplastic layer and the fluoropolymer layer.

Notably, the tubings of the disclosure do not require coupling agents or adhesive layers to adhere the thermoplastic polyurethane layer to the fluoropolymer layer or to the tie layer, which even layer contacts the inner surface of the thermoplastic polyurethane layer.

Of course, in certain embodiments, such materials can be used.

As described above, the tubings of the disclosure can be configured to further include one or more inner annular tie layers disposed on the outside surface of the fluoropolymer layer. Such an embodiment is shown in the cross-sectional schematic view of FIG. 3, discussed above. A variety of polymeric materials can be used as the tie layer. In certain embodiments, the tie layer is formed from at least 75 wt % non-fluorinated polymer. For example, in certain embodiments, the tie layer is formed from at least 80 wt % non-fluorinated polymer, or at least 85 wt % non-fluorinated polymer, or at least 90 wt % non-fluorinated polymer, or at least 95 wt % non-fluorinated polymer, or even at least 98 wt % non-fluorinated polymer. In certain embodiments, the tie layer consists essentially of non-fluorinated polymer. The person of ordinary skill in the art will appreciate that a variety of non-fluorinated polymers can be suitable for use in the tubings described herein. For example, the non-fluorinated polymer is selected from polyamide resins, polyester resins, ethylene acrylic acid and methacrylic acid copolymer resins, polyolefin resins, vinyl chloride-based resins, polyurethane resins, polyaramid resins, polyimide resins, polyamideimide resins, polyphenylene oxide resins, polyacetal resins, polyetheretherketone resins (PEEK), polyetherimide resins, ethylene/vinyl alcohol copolymer-based resins, polyphenylene sulfide resins, polybutylene naphthalate resins, polybutylene terephthalate resins, polyphthalamides (PPA), polyphenylene sulfide (PPS), and a combination or copolymer thereof. In certain desirable embodiments, the non-fluorinated polymer is a polyamide resin.

As the person of ordinary skill in the art would appreciate, a number of other additives may be present in the layers, such as leftover polymerization agent (i.e., from the polymerizations of the thermoplastic polyurethane and/or the fluoropolymer), antioxidants, flame retardants, acid scavengers, anti-static agents and processing aids such as melt flow index enhancers.

The tie layer can be formed in variety of thicknesses. But the inventors have unexpectedly found that the tie layer need not be significantly thicker than the fluoropolymer layer. Thus, in certain embodiments of the tubings as otherwise described herein, the tie layer has a thickness in the range of about 0.010 mm to about 0.200 mm. For example, the tie layer has a thickness in the range of about 0.010 mm to about 0.150 mm, or about 0.010 mm to about 0.130 mm, or about 0.010 mm to about 0.100 mm, or about 0.010 mm to about 0.075 mm, or about 0.030 mm to about 0.200 mm, or about 0.030 mm to about 0.150 mm, or about 0.030 mm to about 0.130 mm, or about 0.030 mm to about 0.100 mm, or about 0.030 mm to about 0.075 mm, or about 0.050 mm to about 0.200 mm, or about 0.050 mm to about 0.150 mm, or about 0.050 mm to about 0.130 mm, or about 0.050 mm to about 0.100 mm, or about 0.050 mm to about 0.075 mm, or about 0.100 mm to about 0.200 mm, or about 0.100 mm to about 0.150 mm, or about 0.100 mm to about 0.130 mm, or about 0.150 mm to about 0.200 mm, or about 0.170 mm to about 0.200 mm.

The tubings of the present disclosure can be made in a wide variety of lengths. In certain embodiments, the length of a length of flexible tubing as otherwise described herein is at least 5 cm. In various embodiments as otherwise described herein, the length of the length of flexible tubing is at least 10 cm, at least 20 cm, at least 30 cm, or even at least 50 cm. In various embodiments as otherwise described herein, the length of the length of flexible tubing is at least 1 m, at least 2 m, at least 3 m, at least 5 m, or even at least 10 m.

The tubings of the present disclosure can be made in a variety of sizes. For example, in certain embodiments of the tubings as otherwise described herein, the inner diameter of the annular cross-section is in the range of 0.5 mm to 40 mm. In various particular embodiments of the flexible tubing as otherwise described herein, the inner diameter of the annular cross-section is in the range of 0.5 mm to 30 mm, or 0.5 mm to 20 mm, or 0.5 mm to 15 mm, or 0.5 mm to 10 mm, or 0.5 mm to 5 mm, or 1 mm to 40 mm, or 1 mm to 30 mm, or 1 mm to 20 mm, or 1 mm to 15 mm, or 1 mm to 10 mm, or 5 mm to 40 mm, or 5 mm to 30 mm, or 5 mm to 20 mm, or 5 mm to 15 mm, or 5 mm to 10 mm, or 10 mm to 40 mm, or 10 mm to 30 mm, or 10 mm to 20 mm. Similarly, in certain embodiments of the tubings as otherwise described herein, the wall thickness of the annular cross-section is in the range of 0.5 mm to 25 mm. In various particular embodiments of the flexible tubing as otherwise described herein, the wall thickness of the annular cross-section is in the range of 0.5 mm to 15 mm, or 0.5 mm to 10 mm, or 0.5 mm to 8 mm, or 0.5 mm to 5 mm, or 0.5 mm to 3 mm, or 0.5 mm to 2 mm, or 1 mm to 25 mm, or 1 mm to 15 mm, or 1 mm to 10 mm, or 1 mm to 8 mm, or 1 mm to 5 mm, or 1 mm to 3 mm, or 2 mm to 25 mm, or 2 mm to 15 mm, or 2 mm to 10 mm, or 2 mm to 8 mm, or 2 mm to 5 mm, or 5 mm to 25 mm, or 5 mm to 15 mm, or 5 mm to 10 mm, or 5 mm to 8 mm, or 10 mm to 25 mm, or 10 mm to 15 mm, or 15 mm to 25 mm.

The description of the tubings herein imply an interface between the layers, (i.e., at the outer surface of the fluoropolymer layer and the inner surface of the thermoplastic polyurethane layer; or the outer surface of the fluoropolymer layer and the inner surface of the tie layer; or the outer surface of the tie layer and the inner surface of the thermoplastic polyurethane layer). As the person of ordinary skill in the art will appreciate, in many real-world samples there will be some intermingling of the materials at the interface. The person of ordinary skill in the art will nonetheless be able to discern where one layer ends and the other begins.

The person of ordinary skill in the art can otherwise prepare the tubings of the disclosure using conventional methods. For example, in certain embodiments, the length of tubing is formed by co-extruding the various layers (e.g., the fluoropolymer layer with the thermoplastic polyurethane layer). Conventional extrusion methods, such as those described in U.S. Pat. Nos. 7,866,348 and 8,092,881, can be used to provide the length of flexible tubing.

The use of a fluoropolymer layer, e.g., using a CPT polymer, can provide the tubings described herein with excellent resistance to permeation of hydrocarbon fuel vapor. For example, in certain embodiments as otherwise described herein, the tubing has a permeation rating of no more than 15 g/m²/day, e.g., no more than 10 g/m²/day, 7 g/m²/day, or 5 g/m²/day, for CE10 at 40° C. using test SAE J1737 conditions. In certain other embodiments as otherwise described herein, the tubing (e.g., such as tubing for use in marine applications) has a permeation rating of no more than 5 g/m²/day, e.g., no more than 4.9 g/m²/day, 4.5 g/m²/day, or 4 g/m²/day, for CE10 at 40° C. using test SAE J1527 conditions.

The tubings described herein show excellent flexibility, such as flexibility required for handheld power equipment and marine applications For example, in certain embodiments as otherwise described herein, the tubing has a composite flexural modulus of no more than 20,000 psi, e.g., no more than 15,000 psi, 10,000 psi, or even no more than 5000 psi, as measured by ASTM D790.

The flexible tubings as described herein are especially useful in the transmission of hydrocarbon fuels. Accordingly, another aspect of the disclosure is a method for transmitting a hydrocarbon fuel, including providing a flexible tubing as described herein, and flowing the hydrocarbon fuel through the tubing from a first end to a second end thereof. A wide variety of hydrocarbon fuels can be used with the tubings of the disclosure, e.g., gasoline, diesel fuel, kerosene.

The tubings described herein can be used to transfer gasoline and other hydrocarbon fuels in engines, such as non-automotive engines. The present disclosure provides a low-permeation design which can be configured to meet the permeation performance requirements of US EPA that requires particularly stringent permeation performance. Thus, another aspect of the disclosure is a fuel-powered device comprising a fuel tank, a fuel-powered engine, and a length of tubing of the present disclosure fluidly connecting the fuel tank with the fuel-powered engine (i.e., configured so as to transmit fuel from the fuel tank to the engine). The engine can be a marine device, such as a boat, or a jet-ski. The engine can be a hand-operated device, such as a lawn tractor, a string trimmer, a leafblower, a snowblower, a lawnmower, a tiller, or a chain saw. The engine can also be an automotive device, such as an automobile, a motorcycle, or a 4-wheel or other recreational vehicles.

Various aspects of the tubings and methods of the disclosure are further described with respect to the non-limiting examples described below.

### Example 1

A three-layer tubing structure having a 3/32″ ID and 3/16″ OD was prepared by conventional co-extrusion methods. The tubing was arranged as presented in FIG. 3, with the an annular fluoropolymer layer being the most inner layer, an annular tie layer disposed on the outside surface of the fluoropolymer layer, and the thermoplastic polyurethane layer disposed on the outside surface of the tie layer. The fluoropolymer layer was NEOFLON™ CPT LP-1030 purchased from Daikin Industries Ltd. and averaged 0.102 to 0.127 mm in thickness. The tie layer was Polyamide 11 (PA11) purchased from Arkema and averaged 0.102 to 0.127 mm in thickness. The thermoplastic polyurethane layer was Desmopan 385A purchased from Covestro and averaged 0.84 to 1.09 mm in thickness.

Additional aspects of the disclosure are provided by the following numbered embodiments, which can be combined and permuted in any number and in any fashion that is not logically or technically inconsistent.

### Embodiment 1

A length of tubing having an annular cross-section, the annular cross-section having an inner surface and an outer surface, the annular cross-section comprising:
an annular fluoropolymer layer formed from at least 75 wt % of a CPT polymer, the fluoropolymer layer having an outer surface and an inner surface; and
an annular thermoplastic layer disposed about the fluoropolymer layer, the thermoplastic layer having an inner surface and an outer surface.

### Embodiment 2

The length of tubing of embodiment 1, wherein the inner surface of the thermoplastic layer is in contact with the outer surface of the fluoropolymer layer.

### Embodiment 3

The length of tubing of embodiment 2, wherein the only two continuous polymeric layers of the tubing are the inner fluoropolymer layer, in contact with the outer thermoplastic layer.

### Embodiment 4

The length of tubing of embodiment 1, further comprising an annular tie layer having an outer surface and an inner surface, wherein the inner surface of the annular layer is in contact with the outer surface of the fluoropolymer layer.

### Embodiment 5

The length of tubing of embodiment 1, further comprising an annular tie layer having an outer surface and an inner surface, wherein the outer surface of the annular tie layer is in contact with the inner surface of the thermoplastic layer.

### Embodiment 6

The length of tubing of embodiment 5, wherein the only three continuous polymeric layers of the tubing are an inner fluoropolymer layer, an outer thermoplastic layer, and a tie layer disposed between them and contacting both.

### Embodiment 7

The length of tubing of any of embodiments 1-6, wherein the fluorinated layer is disposed at the inner surface of the tubing.

### Embodiment 8

The length of tubing of any of embodiments 1-7, wherein the fluoropolymer layer is formed from at least 80 wt % of a CPT polymer, e.g., at least 85 wt % of a CPT polymer, or at least 90 wt % of a CPT polymer.

### Embodiment 9

The length of tubing of any of embodiments 1-7, wherein the fluoropolymer layer is formed from at least 95 wt % of a CPT polymer, e.g., at least 98 wt % of a CPT polymer.

### Embodiment 10

The length of tubing of any of embodiments 1-9, wherein the fluoropolymer layer further comprises a PVDF polymer, a FEP polymer, a PEA polymer, an ETFE polymer, an EFEP polymer, an ECTFE polymer, a PCTFE polymer, a THV polymer, or a combination or copolymer thereof.

### Embodiment 11

The length of tubing of any of embodiments 1-9, wherein the fluoropolymer layer consists essentially of fluoropolymer (e.g., a CPT polymer).

### Embodiment 12

The length of tubing of any of embodiments 1-11, wherein the fluoropolymer layer has a thickness in the range of about 0.010 mm to about 0.200 mm, e.g., about 0.010 mm to about 0.150 mm, or about 0.010 mm to about 0.130 mm, or about 0.010 mm to about 0.100 mm, or about 0.010 mm to about 0.075 mm.

### Embodiment 13

The length of tubing of any of embodiments 1-11, wherein the fluoropolymer layer has a thickness in the range of about 0.030 mm to about 0.200 mm, e.g., or about 0.030 mm to about 0.150 mm, or about 0.030 mm to about 0.130 mm, or about 0.030 mm to about 0.100 mm, or about 0.030 mm to about 0.075 mm.

### Embodiment 14

The length of tubing of any of embodiments 1-11, wherein the fluoropolymer layer has a thickness in the range of about 0.050 mm to about 0.200 mm, or about 0.050 mm to about 0.150 mm, or about 0.050 mm to about 0.130 mm, or about 0.050 mm to about 0.100 mm, or about 0.050 mm to about 0.075 mm.

### Embodiment 15

The length of tubing of any of embodiments 1-11, wherein the fluoropolymer layer has a thickness in the range of about 0.100 mm to about 0.200 mm, or about 0.100 mm to about 0.150 mm, or about 0.100 mm to about 0.130 mm, or about 0.150 mm to about 0.200 mm, or about 0.170 mm to about 0.200 mm.

### Embodiment 16

The length of tubing of any of embodiments 1-11, wherein the fluoropolymer layer has a thickness in the range of about 0.010 mm to about 0.100 mm, or about 0.010 mm to about 0.075 mm, or about 0.030 mm to about 0.100 mm, or about 0.030 mm to about 0.075 mm, or about 0.050 mm to about 0.100 mm, or about 0.050 mm to about 0.075 mm.

### Embodiment 17

The length of tubing of any of embodiments 1-16, wherein the thermoplastic layer is a thermoplastic polyurethane layer formed from at least 75 wt % thermoplastic polyurethane.

### Embodiment 18

The length of tubing of embodiment 17, wherein the thermoplastic polyurethane layer is formed from at least 80 wt % thermoplastic polyurethane (e.g., at least 80 wt % of a polyether-type thermoplastic polyurethane), for example, at least 85 wt % thermoplastic polyurethane, or at least 90 wt % thermoplastic polyurethane.

### Embodiment 19

The length of tubing of embodiment 17, wherein the thermoplastic polyurethane layer is formed from at least 95 wt % thermoplastic polyurethane, or at least 98 wt % thermoplastic polyurethane.

### Embodiment 20

The length of tubing of any of embodiments 17-19, wherein the thermoplastic polyurethane of the thermoplastic polyurethane layer is a polyether-type thermoplastic polyurethane, a polyester-type thermoplastic polyurethane, or a combination or copolymer thereof.

### Embodiment 21

The length of tubing of embodiment 17, wherein the thermoplastic polyurethane layer of the thermoplastic polyurethane layer consists essentially of thermoplastic polyurethane (e.g., a polyether-type thermoplastic polyurethane).

### Embodiment 22

The length of tubing of any of embodiments 1-21, wherein the thermoplastic layer has a thickness in the range of about 0.5 mm to about 20 mm, e.g., 0.5 mm to 10 mm, or 0.5 mm to 5 mm, or 0.5 mm to 3 mm, or 0.5 mm to 2 mm.

### Embodiment 23

The length of tubing of any of embodiments 1-21, wherein the thermoplastic layer has a thickness in the range of 1 mm to 20 mm, e.g., 1 mm to 10 mm, or 1 mm to 5 mm, or 1 mm to 3 mm,

### Embodiment 24

The length of tubing of any of embodiments 1-21, wherein the thermoplastic layer has a thickness in the range of 2 mm to 20 mm e.g., 2 mm to 10 mm, or 2 mm to 7 mm, or 2 mm to 5 mm.

### Embodiment 25

The length of tubing of any of embodiments 1-21, wherein the thermoplastic layer has a thickness in the range of 5 mm to 20 mm, or 5 mm to 15 mm, or 5 mm to 10 mm, or 10 mm to 20 mm.

### Embodiment 26

The length of tubing of any of embodiments 4-25, wherein the tie layer is formed from at least 75 wt % non-fluorinated polymer.

### Embodiment 27

The length of tubing of any of embodiments 4-25, wherein the tie layer is formed from at least 80 wt % non-fluorinated polymer, or at least 85 wt % non-fluorinated polymer, or at least 90 wt % non-fluorinated polymer, or at least 95 wt % non-fluorinated polymer, or at least 98 wt % non-fluorinated polymer.

### Embodiment 28

The length of tubing of any of embodiments 4-25, wherein the tie layer consists essentially of non-fluorinated polymer.

### Embodiment 29

The length of tubing of any of embodiments 26-28, wherein the non-fluorinated polymer is selected from polyamide resins, polyester resins, ethylene acrylic acid and methacrylic acid copolymer resins, polyolefin resins, vinyl chloride-based resins, polyurethane resins, polyaramid resins, polyimide resins, polyamideimide resins, polyphenylene oxide resins, polyacetal resins, polyetheretherketone resins (PEEK), polyetherimide resins, ethylene/vinyl alcohol copolymer-based resins, polyphenylene sulfide resins, polybutylene naphthalate resins, polybutylene terephthalate resins, polyphthalamides (PPA), polyphenylene sulfide (PPS), and a combination or copolymer thereof.

### Embodiment 30

The length of tubing of any of embodiments 26-28, wherein the non-fluorinated polymer is a polyamide resin.

### Embodiment 31

The length of tubing of any of embodiments 4-30, wherein the tie layer has a thickness in the range of about 0.010 mm to about 0.200 mm, e.g., in the range of about 0.010 mm to about 0.150 mm, or about 0.010 mm to about 0.130 mm, or about 0.010 mm to about 0.100 mm, or about 0.010 mm to about 0.075 mm.

### Embodiment 32

The length of tubing of any of embodiments 4-30, wherein the tie layer has a thickness in the range of about 0.030 mm to about 0.200 mm, e.g., in the range of about 0.030 mm to about 0.150 mm, or about 0.030 mm to about 0.130 mm, or about 0.030 mm to about 0.100 mm, or about 0.030 mm to about 0.075 mm.

### Embodiment 33

The length of tubing of any of embodiments 4-30, wherein the tie layer has a thickness in the range of about 0.050 mm to about 0.200 mm, or about 0.050 mm to about 0.150 mm, or about 0.050 mm to about 0.130 mm, or about 0.050 mm to about 0.100 mm, or about 0.050 mm to about 0.075 mm.

### Embodiment 34

The length of tubing of any of embodiments 4-30, wherein the tie layer has a thickness in the range of about 0.100 mm to about 0.200 mm, or about 0.100 mm to about 0.150 mm, or about 0.100 mm to about 0.130 mm, or about 0.150 mm to about 0.200 mm, or about 0.170 mm to about 0.200 mm.

### Embodiment 35

The length of tubing of any of embodiments 1-34, having an inner diameter in the range of 0.5 mm to 40 mm.

### Embodiment 36

The length of tubing of any of embodiments 1-34, having an inner diameter in the range of 0.5 mm to 30 mm, or 0.5 mm to 20 mm, or 0.5 mm to 15 mm, or 0.5 mm to 10 mm, or 0.5 mm to 5 mm, or 1 mm to 40 mm, or 1 mm to 30 mm, or 1 mm to 20 mm, or 1 mm to 15 mm, or 1 mm to 10 mm, or 5 mm to 40 mm, or 5 mm to 30 mm, or 5 mm to 20 mm, or 5 mm to 15 mm, or 5 mm to 10 mm, or 10 mm to 40 mm, or 10 mm to 30 mm, or 10 mm to 20 mm.

### Embodiment 37

The length of tubing of any of embodiments 1-36, wherein the wall thickness of the annular cross-section is in the range of 0.5 mm to 25 mm.

### Embodiment 38

The length of tubing of any of embodiments 1-36, wherein the wall thickness of the annular cross-section is in the range of 0.5 mm to 15 mm, or 0.5 mm to 10 mm, or 0.5 mm to 8 mm, or 0.5 mm to 5 mm, or 0.5 mm to 3 mm, or 0.5 mm to 2 mm, or 1 mm to 25 mm, or 1 mm to 15 mm, or 1 mm to 10 mm, or 1 mm to 8 mm, or 1 mm to 5 mm, or 1 mm to 3 mm, or 2 mm to 25 mm, or 2 mm to 15 mm, or 2 mm to 10 mm, or 2 mm to 8 mm, or 2 mm to 5 mm, or 5 mm to 25 mm, or 5 mm to 15 mm, or 5 mm to 10 mm, or 5 mm to 8 mm, or 10 mm to 25 mm, or 10 mm to 15 mm, or 15 mm to 25 mm.

### Embodiment 39

The length of tubing of any of embodiments 1-38, having a length of at least 5 cm, e.g., at least 10 cm, at least 20 cm, at least 30 cm, or even at least 50 cm.

### Embodiment 40

The length of tubing of any of embodiments 1-38, having a length of at least 1 m, e.g., at least 2 m, at least 3 m, at least 5 m, or even at least 10 m.

### Embodiment 41

The length of tubing of any of embodiments 1-40, wherein the length of tubing exhibits CE10 fuel permeation at 40° C. of no more than 15 g/m²/day, e.g., no more than 10 g/m²/day, 7 g/m²/day, or 5 g/m²/day.

### Embodiment 42

The length of tubing of any of embodiments 1-40, wherein the length of tubing exhibits CE10 fuel permeation at 40° C. of less than 5 g/m²/day, e.g., no more than 4.9 g/m²/day, 4.5 g/m²/day, or 4 g/m²/day.

### Embodiment 43

The length of tubing of any of embodiments 1-42, wherein the tubing has a composite flexural modulus of no more than 20,000 psi, e.g., no more than 15,000 psi, 10,000 psi, or even no more than 5000 psi, as measured by ASTM D790.

### Embodiment 44

A method for transporting a hydrocarbon fuel, comprising providing a length of tubing according to any of embodiments 1-43; and flowing the hydrocarbon fuel through the flexible tubing from a first end to a second end thereof.

### Embodiment 45

A fuel-powered device comprising a fuel tank, a fuel-powered engine, and a length of tubing according to any of embodiments 1-43 fluidly connecting the fuel tank with the fuel-powered engine.

### Embodiment 46

The fuel-powered device of embodiment 45, in the form of a marine device, such as a boat, or a jet-ski.

### Embodiment 47

The fuel-powered device of embodiment 45, in the form of a hand-operated device, such as a lawn tractor, a string trimmer, a leafblower, a snowblower, a lawnmower, a tiller, or a chain saw.

### Embodiment 48

The fuel-powered device of embodiment 45, in the form of an automotive device, such as an automobile, a motorcycle, or a 4-wheel or other recreational vehicles.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

We claim:

1. A length of tubing having an annular cross-section, the annular cross-section having an inner surface and an outer surface, the annular cross-section comprising:
an annular fluoropolymer layer formed from at least 75 wt % of a CPT polymer, the fluoropolymer layer having an outer surface and an inner surface; and
an annular thermoplastic layer disposed about the fluoropolymer layer, the thermoplastic layer having an inner surface and an outer surface.

2. The length of tubing of claim 1, wherein the inner surface of the thermoplastic layer is in contact with the outer surface of the fluoropolymer layer.

3. The length of tubing of claim 2, wherein the only two continuous polymeric layers of the tubing are the inner fluoropolymer layer, in contact with the outer thermoplastic layer

4. The length of tubing of claim 1, further comprising an annular tie layer having an outer surface and an inner surface, wherein the inner surface of the annular layer is in contact with the outer surface of the fluoropolymer layer.

5. The length of tubing of claim 4, wherein the tie layer is formed from at least 75 wt % non-fluorinated polymer.

6. The length of tubing of claim 5, wherein the non-fluorinated polymer is a polyamide resin.

7. The length of tubing of claim 4, wherein the tie layer has a thickness in the range of about 0.010 mm to about 0.200 mm.

8. The length of tubing of claim 1, further comprising an annular tie layer having an outer surface and an inner surface, wherein the outer surface of the annular tie layer is in contact with the inner surface of the thermoplastic layer.

9. The length of tubing of claim 1, wherein the fluorinated layer is disposed at the inner surface of the tubing.

10. The length of tubing of claim 1, wherein the fluoropolymer layer is formed from at least 80 wt % of a CPT polymer.

11. The length of tubing of claim 1, wherein the fluoropolymer layer further comprises a PVDF polymer, a FEP polymer, a PEA polymer, an ETFE polymer, an EFEP polymer, an ECTFE polymer, a PCTFE polymer, a THV polymer, or a combination or copolymer thereof.

12. The length of tubing of claim 1, wherein the fluoropolymer layer consists essentially of fluoropolymer.

13. The length of tubing of claim 1, wherein the fluoropolymer layer has a thickness in the range of about 0.010 mm to about 0.200 mm.

14. The length of tubing of claim 1, wherein the thermoplastic layer is a thermoplastic polyurethane layer formed from at least 75 wt % thermoplastic polyurethane.

15. The length of tubing of claim 14, wherein the thermoplastic polyurethane of the thermoplastic polyurethane layer is a polyether-type thermoplastic polyurethane, a polyester-type thermoplastic polyurethane, or a combination or copolymer thereof.

16. The length of tubing of claim 1, wherein the thermoplastic layer has a thickness in the range of about 0.5 mm to about 20 mm.

17. The length of tubing of claim 1, having an inner diameter in the range of 0.5 mm to 40 mm.

18. The length of tubing of claim 1, wherein the length of tubing exhibits CE10 fuel permeation at 40° C. of less than 5 g/m²/day.

19. A method for transporting a hydrocarbon fuel, comprising
providing a length of tubing according to claim 1; and
flowing the hydrocarbon fuel through the flexible tubing from a first end to a second end thereof.

20. A fuel-powered device comprising a fuel tank, a fuel-powered engine, and a length of tubing according to claim 1 fluidly connecting the fuel tank with the fuel-powered engine.
